(19) United States
(12) Patent Application Publication
(10) Pub. No.: US 2012/0099611 A1
(43) Pub. Date: Apr. 26, 2012

(54) EXTERNAL CAVITY TUNABLE LASER MODULE

(75) Inventors: Byoung Whi Kim, Daejeon (KR); Mahn Yong Park, Daejeon (KR); Geon Jeong, Daejeon (KR)

(73) Assignee: MEL, Daejeon (KR)

(21) Appl. No.: 13/377,733

(22) PCT Filed: Jun. 15, 2009
(86) PCT No.: PCT/KR2009/003184

§ 371 Date: Dec. 12, 2011

(30) Foreign Application Priority Data
Jun. 12, 2009 (KR) 10-2009-0052515

(51) Int. Cl. H01S 3/10

(52) U.S. Cl. 372/20

(57) ABSTRACT

Provided is a wavelength tunable external cavity semiconductor laser module by a thermo-optic effect of a semiconductor optical waveguide. The wavelength tunable external cavity semiconductor laser module includes: a light source generating wideband light; a semiconductor optical waveguide having one end optically coupled to the light source; a Bragg grating formed on the optical waveguide; a thin film heater provided at an upper portion of the Bragg grating and controlling a reflection band of the Bragg grating by a thermo-electric effect; a first temperature sensor provided at an upper portion of the optical waveguide; a thermoelectric cooler (TEC) provided at a lower portion of the optical waveguide; a heat insulating layer provided between the optical waveguide and the TEC; and an optical fiber optically coupled to the other end of the optical waveguide.

### TECHNICAL FIELD

The present invention relates to a wavelength tunable external cavity semiconductor laser module capable of being manufactured through an advanced semiconductor process technology, being stably and accurately waveform-tunable, and having excellent long term reliability and reproducibility of an oscillating waveform at the time of tuning of the wavelength.

### BACKGROUND ART

In accordance with the recent increase in the demand for communication capacity due to the progress of informationization and the diffusion of the Internet, a wavelength division multiplexing (hereinafter, referred to as a WDM) optical system has been developed toward increasing the number of channels according to the densification of an interval between wavelength channels as well as increasing a transmission speed of a light signal in order to increase a bandwidth.

Furthermore, the interest in a WDM based passive optical network (PON) as a method of increasing a communication bandwidth in a subscriber network has gradually increased.

In the WDM-PON, which is a scheme of performing communication between a central office and subscribers using each wavelength determined for each subscriber, since wavelengths dedicated to each subscriber are used, security is excellent, a large capacity of communication service may be provided, and different transmission technologies (for example, a link rate, a frame format, or the like) may be applied for each subscriber or each service.

However, since the WDM-PON is a technology of multiplexing several wavelengths in a single optical fiber using the WDM technology, it requires light sources having different wavelengths corresponding to the number of subscribers pertaining to a single remote node (RN).

The production, installation, and management of the light sources for each wavelength impose a large economic burden on both of users and operators to block commercialization of the WDM-PON.

In order to solve this problem, research into a method of applying a wavelength tunable light source capable of selectively controlling a wavelength of an output light source has been actively conducted.

A wavelength tunable semiconductor laser may be divided into a single integrated laser such as distributed feedback (DFB) laser or a distributed Bragg reflector (DBR) laser and an external cavity laser (ECL).

The DFB laser may control an oscillating wavelength using a thermo-optic effect that a refractive index is changed by heat since the oscillating wavelength is determined by a grating period and an effective refractive index. However, the DFB laser has a wavelength tunable range of 10 nm or less since a relative temperature capable of being applied to an element is significantly restrictive due to gain deterioration.

Since a sampled grating (SG)-DBR laser controls an oscillating wavelength by applying current to a Bragg grating region, it has a wider wavelength tunable range and a more rapid control speed as compared to the DFB laser thermally controlling the oscillating wavelength. However, the SG-DBR laser is not appropriate as a low cost light source since an optical amplifier should be additionally integrated in order to compensate for absorption loss by free carriers applied to the Bragg grating region and a manufacturing process is significantly complicated.

In the external cavity laser, a resonator is configured by optical coupling between an optical gain medium such as a reflective optical amplifier or a laser diode (LD) and a wavelength selection type reflective filter such as an optical fiber Bragg grating or a planar waveguide Bragg grating, such that an oscillating wavelength is determined by a wavelength fed back from the reflective filter to the gain medium.

Since a reflection wavelength of the optical fiber Bragg grating or the waveguide Bragg grating is determined by a grating period and an effective refractive index of the waveguide, the reflection wavelength may be controlled using a thermo-optic effect that a refractive index is changed by heat.

In the case of the optical fiber Bragg grating, silica, which is a material of an optical fiber, has a thermo-optic coefficient of about 1.1×10⁻⁵/K, and a reflection wavelength of the optical fiber Bragg grating has significant small temperature dependency of about 0.01 nm/K. Therefore, as a method of mechanically extending the optical fiber Bragg grating, a method of changing a grating period is used. In the method of tuning a wavelength as described above, the optical fiber Bragg grating is easily damaged by physical stress and a wavelength tunable range is also not large.

On the other hand, in the case of a polymer based waveguide Bragg grating, a polymer has a thermo-optic coefficient of about −1×10⁻⁴/K to −3×10⁻⁴/K, that is, temperature dependency 10 times or more higher than that of the silica, such that a 30 nm or more wavelength may be tuned only with the thermo-optic effect.

A polymer optical waveguide based wavelength tunable external cavity laser generally uses a heating element having a metal thin film shape at an upper end of an optical waveguide in order to tune an oscillating wavelength by changing a refractive index of the polymer and uses a temperature control device including a thermoelectric cooler and a temperature sensor for an operation unrelated to an external temperature environment.

In the case of the above-mentioned structure, as a temperature of the metal thin film heating element increases, a temperature gradient between the heating element and the thermoelectric cooler increases, and local stress is applied to a waveguide in a heating element region.

Further, in the case of a technology of utilizing a polymer optical waveguide based wavelength tunable filter using a thermo-optic effect as an output coupler of the external cavity laser, as heat is applied to a polymer material for a long period of time, the polymer material is degraded and local stress is generated due to a temperature gradient, such that a refractive index is changed, thereby deteriorating stability of an oscillating wavelength. Particularly, it is significantly difficult to secure stability of the level required by a WDM optical communication system having 100 GHz interval.

The change in an effective refractive index of the waveguide due to the above-mentioned cause makes it difficult to a wavelength control of the level required by the WDM optical communication system and limits a wavelength tunable range.

In addition, in the case in which heat is locally applied to the polymer through the metal thin film heating element for a long period of time, the polymer material is degraded and the degraded polymer material again applies stress to the metal thin film heating element, such that the metal thin film heating element is deteriorated and short-circuited.

### TECHNICAL PROBLEM

An object of the present invention is to provide a wavelength tunable external cavity semiconductor laser module having a high production yield and a low cost and capable of being mass-produced by being manufactured based on an advanced silicon semiconductor process; a wavelength tunable external cavity semiconductor laser module having significant high stability and reproducibility of an oscillating waveform at the time of tuning of the wavelength and high thermal/optical/mechanical stability and durability; and a wavelength tunable external cavity semiconductor laser module being unrelated to an external thermal environment, having high optical coupling efficiency, and capable of stably tuning a wavelength in a short time.

### TECHNICAL SOLUTION

In one general aspect, a wavelength tunable external cavity semiconductor laser module includes: a light source generating wideband light; a semiconductor optical waveguide having one end optically coupled to the light source; a Bragg grating formed on the optical waveguide; a thin film heater provided at an upper portion of the Bragg grating and controlling a reflection band of the Bragg grating by a thermo-electric effect; a first temperature sensor provided at an upper portion of the optical waveguide; a thermoelectric cooler (TEC) provided at a lower portion of the optical waveguide; a heat insulating layer provided between the optical waveguide and the TEC; and an optical fiber optically coupled to the other end of the optical waveguide.

The light source may be a TO-CAN packaged light source including a semiconductor laser diode chip generating the light and a photo diode detecting intensity of the generated light, the light source and the semiconductor optical waveguide may be optically coupled to each other by an optical lens, and the optical lens may be adhered integrally with the TO-CAN packaged light source. The wavelength tunable external cavity semiconductor laser module may further include a second temperature sensor, wherein the second temperature sensor is provided between the heat insulating layer and the TEC.

The light source may be a light source including a spot size converter integrated therein, and a semiconductor laser diode chip and a photo diode mounted on a sub-mount, the semiconductor laser diode chip generating the wideband light and the photo diode detecting intensity of the generated light, the light source may be provided at an upper portion of the TEC and the light source and the optical waveguide are optically coupled to each other by butt coupling, and the light source and the TEC may include a metal layer provided therebetween. The wavelength tunable external cavity semiconductor laser module may further include a second temperature sensor, wherein the second temperature sensor is provided between the metal layer and the TEC.

The wavelength tunable external cavity semiconductor laser module may further include an optical fiber support supporting the optical fiber, wherein the light source, the optical waveguide having the Bragg grating formed thereon, the thin film heater, the first temperature sensor, the TEC, and the second temperature sensor are provided in a single housing, and the optical fiber is fixed to the housing by the optical fiber support.

The optical waveguide and the optical fiber may be optically coupled to each other by optical lens coupling or butting coupling. Preferably, the optical waveguide and the optical fiber may be optically coupled to each other by the butt coupling, and the optical fiber may be a lens type optical fiber (lensed fiber).

The optical waveguide may be a silicon optical waveguide formed in a silicon on insulator (SOI) substrate including a lower silicon layer, a buried silicon oxide layer, and an upper silicon layer and including a silicon core, a lower clad, which is the buried silicon oxide layer, and an upper clad formed of air or silicon oxide. The Bragg grating may be formed by selectively etching the silicon core and may be formed of the air or the silicon oxide.

The optical waveguide may be a silicon optical waveguide having a channel shape, a rib shape, or a ridge shape, the Bragg grating may have a structure in which at least one Bragg grating is connected in series with each other, and the at least one Bragg grating may be a first order Bragg grating, a third order Bragg grating, a fifth order Bragg grating, or an nth order Bragg grating (n is an odd number larger than 5) independent of each other.

The heat insulating layer may be formed of glass, and the metal layer may be formed of Al or Cu having high thermal conductivity.

The wavelength tunable external cavity semiconductor laser module may further include a control unit, wherein the control unit receives each of outputs of the first and second temperature sensors to control voltage or current applied to the TEC and the thin film heater.

### ADVANTAGEOUS EFFECTS

With the wavelength tunable external cavity semiconductor laser module according to the present invention, a semiconductor material based wavelength tunable filter is used and a wavelength-locking function using a temperature sensor and a thermo-electric cooler is provided, thereby making it possible to obtain an oscillating wavelength having stability, reproducibility, and reliability. In addition, the wavelength tunable semiconductor laser module is manufactured by an advanced semiconductor process, thereby making it possible to increase a production yield and reduce a cost. Further, stability and reproducibility of a wavelength at the time of tuning of the wavelength are high due to thermal/mechanical stability of an SOI based silicon optical wavelength, and the wavelength may be reliably tuned even for a long period of time.

Furthermore, a wavelength reflected by a Bragg grating filter may be precisely and stably controlled and maintained by first and second temperature sensors, a thin film heater, and a thermo-electric cooler, and wavelength-locking characteristics are significantly stable by the precisely controlled and maintained thermal environment and thermal stability of the silicon.

Moreover, components of an optical module including a light source, an optical waveguide having a Bragg grating formed thereon, a thin film heater, a first temperature sensor, a thermo-electric cooler, and a second temperature sensor are included in a single housing, such that thermal/mechanical stability and durability are high.

### DESCRIPTION OF DRAWINGS

The above and other objects, features and advantages of the present invention will become apparent from the following description of preferred embodiments given in conjunction with the accompanying drawings, in which:

FIG. 1 is a view showing a structure of a wavelength tunable external cavity semiconductor laser module according to the present invention.

FIG. 2 is a view showing a structure of a silicon waveguide Bragg grating using a silicon-on-insulator (SOI) substrate as an example of a semiconductor waveguide Bragg grating according to the present invention.

FIG. 3 is a view showing intensity distribution of single mode light of a rib waveguide using the SOI substrate according to the present invention.

FIG. 4 is a view showing simulation results of reflectivity and a reflection band of light with respect to an etch depth of a silicon waveguide Bragg grating according to the present invention.

FIG. 5 is a view showing the wavelength tunable external cavity semiconductor laser module according to an exemplary embodiment of the present invention, wherein FIG. 5A shows an example of butt-coupling between an optical fiber and an optical waveguide and FIG. 5B shows an example of optical lens coupling.

FIG. 6 is view showing simulation results of a relative temperature of an optical waveguide region according to thermal characteristics of a heat insulating substrate included in the wavelength tunable external cavity semiconductor laser module according to the present invention.

FIG. 7 is a view showing a temperature control algorithm of the wavelength tunable external cavity semiconductor laser module according to the present invention.

FIG. 8 is a view showing a wavelength tunable external cavity semiconductor laser module according to another exemplary embodiment of the present invention, wherein FIG. 8A shows an example of butt-coupling between an optical fiber and an optical waveguide and FIG. 8B shows an example of optical lens coupling.

FIG. 9 is a view showing simulation results of optical coupling efficiency according to an interval between a light source and an optical waveguide at the time of optical coupling by butt coupling between the light source and the optical waveguide in an example of the wavelength tunable external cavity semiconductor laser module according to the present invention.

[Detailed Description of Main Elements]

| 100: | light source | 120: | wavelength tunable |
|---|---|---|---|
| filter | | | |
| 105: | semiconductor substrate | 106: | semiconductor |
| optical waveguide | | | |
| 107: | Bragg grating | 113: | optical fiber |
| 110: | thermoelectric cooler | 111: | second |
| temperature sensor | | | |
| 112: | first temperature sensor | 511: | housing |
| 109: | heat insulating layer | 512: | metal layer |
| 104, 513: | optical coupling lens | | |

### BEST MODE

Hereinafter, a wavelength tunable external cavity semiconductor laser module according to the present invention will be described in detail with reference to the accompanying drawings. The drawings to be provided below are provided by way of example so that the idea of the present invention can be sufficiently transferred to those skilled in the art to which the present invention pertains. Therefore, the present invention is not be limited to the drawings provided below but may be modified in many different forms. In addition, like reference numerals denote like elements throughout the specification.

Technical terms and scientific terms used in the present specification have the general meaning understood by those skilled in the art to which the present invention pertains unless otherwise defined, and a description for the known function and configuration obscuring the present invention will be omitted in the following description and the accompanying drawings.

The wavelength tunable external cavity semiconductor laser module according to the present invention is configured to include a light source outputting multi-wavelength light having a wide band, a semiconductor optical waveguide, a Bragg grating formed on the semiconductor optical waveguide, a thin film heater positioned at an upper portion of the optical waveguide on which the Bragg grating is formed, a first temperature sensor, a thermoelectric cooler (TEC), and an optical fiber. In addition, the wavelength tunable external cavity semiconductor laser module according to the present invention further includes a second temperature sensor.

The light source is optically coupled to one end of the semiconductor optical waveguide on which the Bragg grating is formed to thereby configure an external resonator, a reflection wavelength band of the Bragg grating is controlled using a thermo-optic effect of the thin film heater, and an oscillating wavelength is output by resonance through the optical fiber optically coupled to the other end of the semiconductor optical waveguide.

The first temperature sensor is positioned at an upper portion of the semiconductor optical waveguide and measure a temperature of the optical waveguide in real time in order to implement a precise and stable wavelength-locking function, thereby controlling current applied to the thin film heater.

In order to control a heat generation amount for electric power applied to the thin film heater regardless of an external environment temperature of the wavelength tunable external cavity semiconductor laser module to thereby generate a precise thermo-optic effect, the thermoelectric cooler may be positioned at a lower portion of the semiconductor optical waveguide, and the second temperature sensor for precisely controlling a heat absorption amount of the thermo-electric cooler may be positioned at an upper portion of the thermoelectric cooler.

More specifically, wideband light emitted from the light source is input to a core of the semiconductor optical waveguide by optical coupling, and an oscillating wavelength having the central wavelength of the reflection band of the Bragg grating is obtained by resonance that light having a wavelength reflected from the Bragg grating formed on the semiconductor optical waveguide is re-input to a light emitting surface of the light source.

The second temperature sensor is provided between the semiconductor optical waveguide and the thermo-electric cooler, or the light source is positioned at an upper portion of the thermo-electric cooler and the second temperature sensor is positioned between the light source and the thermo-electric cooler.

The light source and the semiconductor optical waveguide are optically coupled to each other by optical lens (an optical coupling lens) coupling or butt coupling, and the semiconductor optical waveguide and the optical fiber are optically coupled to each other by optical lens (an optical coupling lens) coupling or butt coupling independent of the optical coupling form between the light source and the semiconductor optical waveguide.

The thin film heater generates Joule heat when a predetermined electrical signal is applied to a metal thin film, thereby tuning a temperature of the semiconductor optical waveguide on which the Bragg grating is formed and controlling the reflection wavelength band reflected from the Bragg grating by a thermo-optic effect (a thermo-optic coefficient of 1×10⁻⁴/° C.) of the semiconductor optical waveguide.

The first temperature sensor or the second temperature sensor may be configured to include an element having a voltage, resistance, or current amount changed by heat and used in a general temperature sensor, for example, a thermistor.

The thermo-electric cooler may be configured to include a general thermo-electric element generating heat absorption by a predetermined electrical signal.

In the light source, which is a semiconductor optical amplifier or a semiconductor laser diode chip, the light emitting surface is anti-reflection (hereinafter, referred to as AR) coated to have reflectivity of 1% or less and an opposite surface to the light emitting surface is high-reflection (hereinafter, referred to as HR) coated to have reflectivity of 80% or more.

Preferably, the light source, which is a semiconductor laser diode chip for oscillating a wideband wavelength, may be configured to include an active layer generating the light, a current blocking layer, a p-metal layer, and an n-metal layer and be formed of a combination of group III-V elements or a combination of II-IV elements such as InGaAsP, InGaAlAs, InAlAs, or the like, on an InP substrate, wherein the active layer may have a multi-quantum-well structure or a bulk active structure.

The optical waveguide on which the Bragg grating may be formed of a semiconductor material having a combination of group III-V elements such as silicon or indium phosphide (InP) using a silicon on insulation (SOI) substrate including a lower silicon layer, a buried silicon oxide layer, and an upper silicon layer, and the core of the optical waveguide may geometrically have a channel structure, a rib structure, or a ridge structure.

The Bragg grating may be manufactured by forming grooves at a predetermined period in the semiconductor optical waveguide in a movement direction of the light, wherein an empty space (air) of the groove forms the Bragg grating or a heterogeneous material having a refractive index lower than a material of the core of the optical waveguide such as a silicon oxide, poly-silicon is filled in the groove to form the Bragg grating. The Bragg grating may have a grating order of an odd-order of a first order or higher order.

The light source may be optically coupled to the semiconductor optical waveguide through active alignment in a TO-CAN packaged form in which it has the optical coupling lens adhered integrally therewith, and the light source and the semiconductor optical waveguide may be optically coupled to each other through the optical coupling lens or the butt optical coupling on a single optical bench and then packaged.

In the optical coupling lens, each of numerical aperture (NA) values at a light source side and a semiconductor optical waveguide side may be the same as NA values of the light source and the optical waveguide and each surface may be AR coated.

At the time of the optical coupling between the light source and the semiconductor optical waveguide, in order to increase coupling efficiency, the semiconductor optical waveguide may be tilted at an angle satisfying the Snell's law and a movement direction of the light moving to a free space between the light source and the semiconductor optical waveguide. The tilting includes tilting of a partial region including a light incident surface of the semiconductor optical waveguide and tilting of the entire semiconductor optical waveguide.

More specifically, the light incident surface of the semiconductor optical waveguide may be AR coated to have reflectivity of 1% or less, thereby minimizing reflection on the light incident surface of the semiconductor optical waveguide, the light incident surface may have a tilt of 4 degrees or more in the movement direction of the light, and the core of the semiconductor optical waveguide may be formed at an angle satisfying the Snell's law with respect to an angle at which the light is incident to the light incident surface.

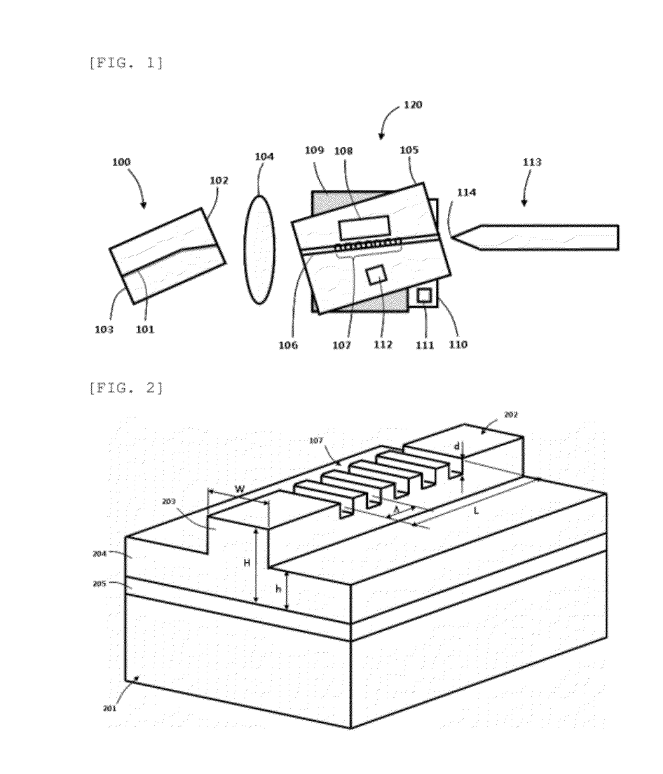

FIG. 1 is a view showing a configuration of a wavelength tunable external cavity semiconductor laser module according to the present invention. A light source 100 generating multi-wavelength light having a wide band and a wavelength tunable filter 120 are optically coupled to each other by an optical coupling lens 104, such that a rear surface 103 of the light source 100 and a Bragg grating 107 formed on a semiconductor optical waveguide 106 of the wavelength tunable filter 120 form a resonator to allow light corresponding to a reflection wavelength by the Bragg grating 113 to resonate and be oscillated, and the light oscillated as described above is optically coupled and output to an optical fiber 113.

A light emitting surface 102 of the light source 100 may be AR coated to have reflectivity of 1% or less in order to suppress Fabry-Perot (FP) mode oscillation due to the reflection on the light emitting surface 102, and the rear surface 103 thereof may be HR coated to have reflectivity of 80% or more in order to improve a Q-factor of an external resonator. In addition, an optical waveguide region 101 of the light source 100 may be formed of an optical active layer or a passive optical waveguide optically coupled to the optical active layer, be formed to have an angle of 4 to 8 degrees with respect to the light emitting surface 102 in order to reduce the reflection on the light emitting surface 102, and be formed to be vertical to the rear surface 103 in order to obtain large reflectivity.

AR coatings having reflectivity of 1% or less may be formed on both surface of the optical coupling lens 104 to prevent light output from the light source 100 or light reflected from the Bragg grating 113 from being reflected on the surfaces of the optical coupling lens. Further, in order to obtain the maximum coupling effect, in the optical coupling lens 104, which is an aspherical lens, a numerical aperture (NA) value at a light source side may be similar to an NA value of the light source 100, and an NA value at an optical waveguide 106 side may be similar to an NA value of the optical waveguide. An end surface of the optical fiber 113 may be a lens type optical fiber or have a tilt of 4 degrees or more, and be tilted to satisfy the Snell's law, and be AR coated to have reflectivity of 1% or less.

In the wavelength tunable filter 120, a waveguide core 106 through which light moves by internal reflection is formed on the semiconductor substrate 105, and grooves are formed at a predetermined period on the core in a movement direction of the light to manufacture the Bragg grating 107. The periodic grooves apply periodic perturbation to a refractive index of the waveguide through which the light moves. Here, a wavelength (λ_{B}) reflected by the Bragg grating is determined by a grating Equation (Equation 1).

mλ_{B}=2n_{eff}Λ (Equation 1)

In the above Equation 1, m means a grating order, n_{eff} means an effective refractive index of the optical waveguide, and Λ means a period of the Bragg grating.

From the grating Equation, a change in a Bragg reflection wavelength according to a temperature is derived as represented by Equation 2.

mdλ_{B}/dT=2d(n_{eff}Λ)/dT=λ₀(1/n_{eff}dn_{eff}/dT+1/ΛdΛ/dT) (Equation 2)

In the above Equation 2, m and n_{eff}, and Λ are the same as those of Equation. 2, and λ₀ means an initial reflection wavelength. A change amount in a reflection wavelength according to a temperature is in proportion to the sum of a change amount in an effective refractive index according to a temperature and a change amount in a grating period according to a temperature. For example, assuming a silicon waveguide Bragg grating having a grating order (m) of 1 and an initial wavelength (λ₀) of 1550 nm, it could be appreciated that a change in a reflection wavelength is 0.085 nm/K for a temperature and a temperature for 12 nm tuning corresponding to sixteen channels having an interval of 100 GHz is about 142 K. In the above-mentioned example, a thermo-optic coefficient (n_{eff}/T) of silicon was 1.9×10⁻⁴/K, and a change in a period due to the temperature was ignored.

In order to control the reflection wavelength of the Bragg grating 107 using the thermo-optic effect as described above, a thin film heater 108 including a heating element having a metal thin film shape may be provided on the semiconductor substrate 105. The heating element is formed by depositing a metal material Cr, Au, Ni, Ni/Cr, TiW, or the like, at an appropriate thickness.

In order to allow a heat generation amount for electric power applied to the heating element to be constant regardless of an external environment temperature, a temperature control device including a thermo-electric cooler 110 and a second temperature sensor 111 including a thermistor may be provided at a lower portion of the semiconductor substrate 105.

Here, in order to minimize electric power consumption of the heating element, a heat insulating layer 109 may be provided between the semiconductor substrate 105 and the thermo-electric cooler 110. In addition, a first temperature sensor 112 for monitoring a temperature applied to the Bragg grating 107 in real time to control current applied to the heating element is mounted on the semiconductor substrate 105.

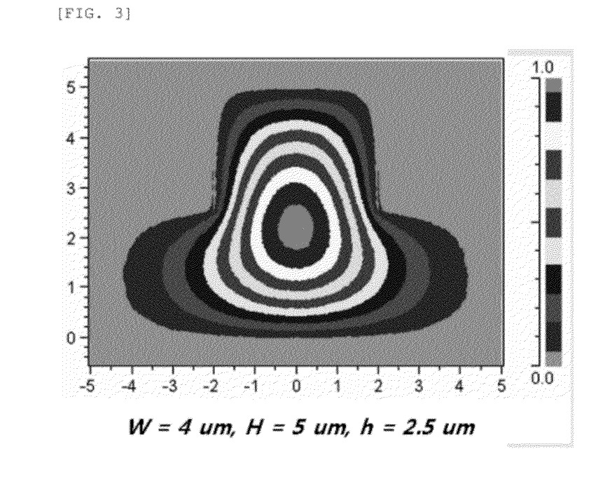

FIG. 2 is a view showing a structure of a silicon waveguide Bragg grating using an SOI substrate 201 as an example of the wavelength tunable filter 120. As an example of FIG. 2, a geometric structure of an optical waveguide is a rib waveguide structure and is configured of a rib region 203 and a slap region 204 The rib waveguide 202 is formed at an upper silicon region of the SOI substrate 201. Here, the light may be confined by an insulating layer 205, which is a buried silicon oxide layer, formed at a lower portion of the rib waveguide 202 and an air layer at an upper portion thereof or a cover layer (not shown) having a refractive index lower than that of silicon such as an silicon oxide, in a direction vertical to a cross-section of the rib waveguide 202, and the light may be propagated without being confined or lost due to a difference in an effective refractive index by the rib region 203, in a direction horizontal thereto. Here, the rib waveguide 202 becomes a single mode condition when a relationship between a width (W) and a height (H) of the rib region 203 and a height (h) of the slap region 203 satisfies the following Equation 3.

W/H<r/Sqrt(1−r²) (Equation 3)

Where r, which means a ratio (h/H) of the slap region 203 to the rib region 202, is a value larger than 0.5 and smaller than 1, and the height (H) of the rib region needs to satisfy a restrictive condition as represented by Equation 4.

H=λ/Sqrt(n_{Si}²−n_{SiO2}²) (Equation 4)

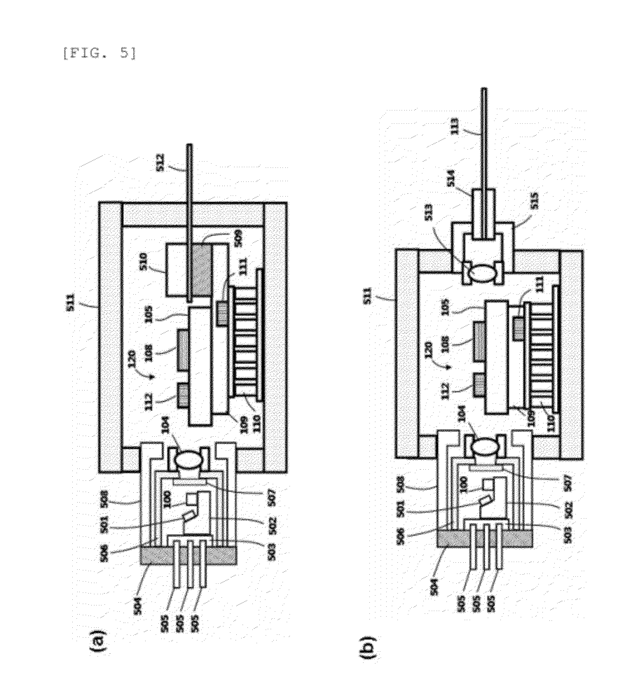

In FIG. 4, λ means a wavelength of light in a free space, and n_{Si} and n_{SiO2} mean reflective indices of Si and SiO₂, respectively.

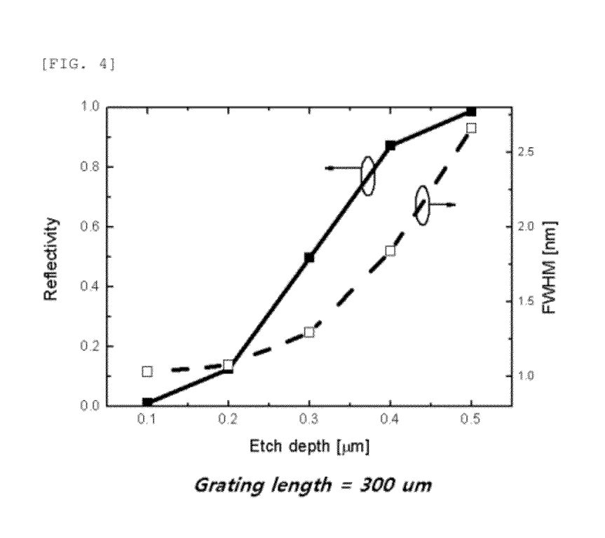

For example, intensity distribution of single mode light of a rib waveguide of which W=4 μm, H=5 μm, and h=2.5 μm is shown in FIG. 3.

As shown in FIG. 2, the Bragg grating 107 is manufactured by forming grooves at a predetermined period in an upper portion of the rib waveguide 202. According to the present invention, the groove is formed using an etching method. Generally, a dry etching method using a reactive ion etching (RIE) is preferable.

In manufacturing the Bragg grating 107, a wavelength of reflection light by the Bragg grating is in proportion to a period (Λ) of the grading as described above, and reflectivity and a reflection band thereof depend on a groove depth (d) and a grating length (L). In the case in which a grating order is 1 and a grating length (L) is 300 μm in the rib waveguide structure in the above-mentioned example, simulation results of reflectivity and full width half maximum (FWHM) of reflection light according to the groove depth (d) are shown in FIG. 4.

As seen in FIG. 4, as the groove depth (d) (represented by an etch depth in FIG. 4) increases, the reflectivity increases and the FWHM also increases. Generally, the reflectivity tends to increase and the FWHM tends to decrease when the grating length (L) increases. Therefore, it is possible to manufacture a Bragg grating having desired reflectivity and FWHM by controlling the etch depth and grating length.

The Bragg grating 107 may be filled with a cover layer. Here, the cover layer may be formed of a thermal oxide film or a silicon oxide deposited through a chemical vapor deposition method.

The Bragg grating 113 may have a grating order of an odd high-order of a first order or a third order or higher order.

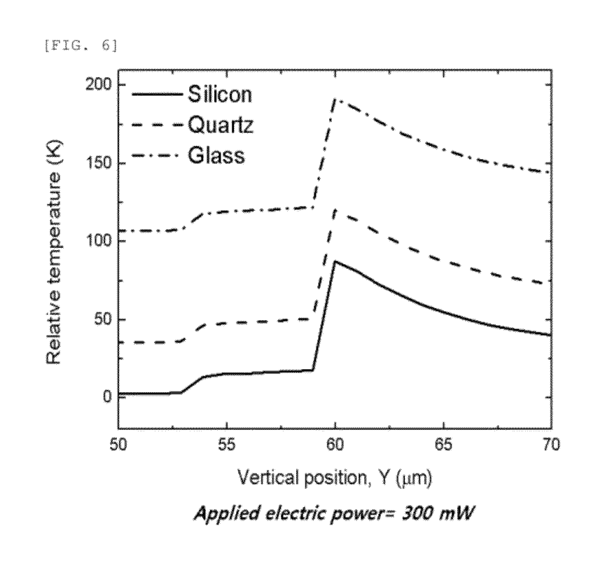

FIGS. 5A and 5B are views showing examples for implementing a structure of the wavelength tunable external cavity semiconductor laser module according to an exemplary embodiment of the present invention described with reference to FIG. 1, respectively. The light source 100 is packaged in a TO-CAN form in which it includes the optical coupling lens 104, and is optically coupled to the wavelength tunable filter 120 packaged in a single housing 511 through the optical coupling lens 104.

More specifically, the light source 100 includes a photodiode 501 for monitoring a change in optical output intensity and is mounted on an ‘L’ shaped sub-mount 502, and is positioned, whereby the sub-mount 502 is positioned at an upper portion of a stem 504. Here, a temperature control device 503 including a thermo-electric cooler and a second temperature sensor including a thermistor is positioned at the upper portion of the stem 504 and a lower portion of the sub-mount 502 in order to allow an optical gain of the light source 100 to be constantly maintained regardless of an external environment temperature. In addition, lead frames 505 for driving the light source 100 and the photodiode 501 or the temperature control device 503 are provided in the stem 504 and are wire-bonded to the light source 100, the photodiode 501, the temperature control device 503, and the like. The optical coupling lens 104 is arranged and mounted together with a window-glass 507 on an optical axis output from the light source 100 at an upper portion of a window of a cap 506 for hermitic-sealing.

In the wavelength tunable filter 120, the thin film heater 108 including the metal thin film heating element and the first temperature sensor 112 are positioned on the substrate 105 including the optical waveguide in which the Bragg grating is formed as described above with reference to FIGS. 1 and 2. A temperature control device including the thermo-electric cooler 110 and the second temperature sensor 111 including the thermistor is adhered to an internal bottom surface of the housing 511, the heat insulating layer 109 is mounted on the thermo-electric cooler 110, and the semiconductor substrate 105 is then mounted on the heat insulating layer 109. Here, a surface of the thermo-electric cooler 110 adhered to the internal bottom surface of the housing 511 may be a heating surface. In order to increase heat radiation efficiency, the housing 511 may be formed of a metal material having thermal conductivity such as Al, and the thermo-electric cooler 110 may be adhered to the housing 511 using a thermosetting resin having large thermal conductivity at the time of adhesion therebetween.

The housing 511 may include lead frames (not shown) provided on a side or a lower surface thereof in order to drive the temperature control device, the heating element, the temperature sensor, and the like, and be hermitically sealed.

Single wavelength light oscillated in a resonator structure formed by the light source 100 and the wavelength tunable filter 120 may be output through the optical fiber 113, and a lens type optical fiber 512 or an optical coupling lens may be used as a structure for increasing optical coupling efficiency between the optical fiber 113 and the semiconductor optical waveguide 106. In the case of using the lens type optical fiber 512, as shown in FIG. 5A, the lens type optical fiber 512 may be mounted on the heat insulating layer 109 using an optical fiber support 509 including a V-groove so that it is fixed. The lens type optical fiber 113 and the support 509 may be fixed to each other through laser-welding using a metal ferrule or be fixed to each other using a thermosetting resin or an ultraviolet-curable resin and adhesion strength therebetween may be increased using an additional cover support 510. In the case of using the optical coupling lens, as shown in FIG. 5B, the optical fiber 113 may be fixed to a metal ferrule 514 to thereby be fixed together with an optical coupling lens 513 to a metal sleeve 515 so as to be spaced apart from the optical coupling lens 513 by an interval corresponding to a focal length of the optical coupling lens 513. Here, in the optical coupling lens 513, which is an aspherical lens, each of NA values at an optical fiber 113 side and an optical waveguide 106 side may be similar to those of the optical fiber 113 and the optical waveguide 106. In addition, AR coatings having reflectivity of 1% or less may be formed on both surfaces of the optical coupling lens 513 to prevent the light from being reflected from the surfaces of the optical coupling lens 513.

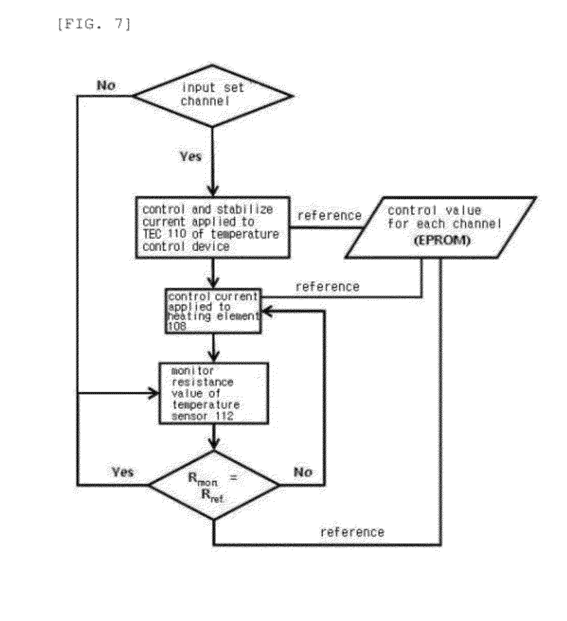

In the case in which the heat insulating layer 109 has large thermal conductivity, a temperature control according to current applied to the heating element 108 for tuning the wavelength may be rapidly performed; however, heat radiation efficiency through the thermo-electric cooler 110 is significantly large, such that electric power consumption is large. On the other hand, in the case in which the heat insulating layer 109 has small thermal conductivity, electric power consumption is reduced; however, a temperature control speed is reduced. Simulation results of a relative temperature of an optical waveguide region according to a kind of heat insulating layer 109 are shown in FIG. 6. It was assumed in the simulation that the semiconductor substrate 105 is an SOI substrate having a thickness of 100 μm and the heat insulating layer 109 has a thickness of 50 μm, and a material of the heat insulating layer 109 used in the simulation was silicon, quartz, or glass. Heat capacity and thermal conductivity of the above-mentioned materials are shown in the following Table 1.

TABLE 1

| | Heat capacity | Thermal conductivity |
|---|---|---|
| | [× 10⁶ J/K/m³] | [W/m/K] |
| Silicon | 1.66 | 149 |
| Quartz | 3.0 | 2.13 |
| Glass | 2.18 | 0.93 |

In the simulation of FIG. 6, two-dimensional approximation to a cross section of the semiconductor substrate 105 having the heating element 108 mounted thereon was performed, and as boundary conditions, a lower portion of the heat insulating layer 109 has contacted a heat sink and an upper portion, and left and right sides thereof, which are remaining portions of a calculating region, were considered as complete heat insulating surfaces. Simulation results when electric power of 300 mW is applied to the heating element under the above-mentioned condition is that a relative temperature of the rib waveguide region (from 54 μm to 59 μm in a Y-axis position) is 17 K in the case of the silicon substrate, is 49 K in the case of the quartz substrate, and is 120 K in the case of the glass substrate. As described above, it could be appreciated that as thermal conductivity of the heat insulating layer 109 becomes small, a heat generation amount for the electric power applied to the heating element increases.

The heat insulating layer 109 according to the present invention is formed of glass having small thermal conductivity. A thickness of the heat insulating layer 109 is increased and a contact area between the wavelength tunable filter and the semiconductor substrate is decreased, thereby making it possible to minimize the electric power consumption of the heating element 108 for tuning the wavelength.

However, as described above, in the above-mentioned structure, a temperature control speed is reduced, such that a long stabilization time is required at the time of tuning of the wavelength. In order to solve this problem, according to the present invention, as shown in FIGS. 1 and 5, the first temperature sensor 112 is provided on the semiconductor substrate 105 having the optical waveguide formed thereon to monitor and control a temperature of the semiconductor substrate 105 having the optical waveguide formed thereon in real time by the thin film heater 108, thereby making it possible to reduce a wavelength stabilization time according to temperature stabilization at the time of the tuning of the wavelength.

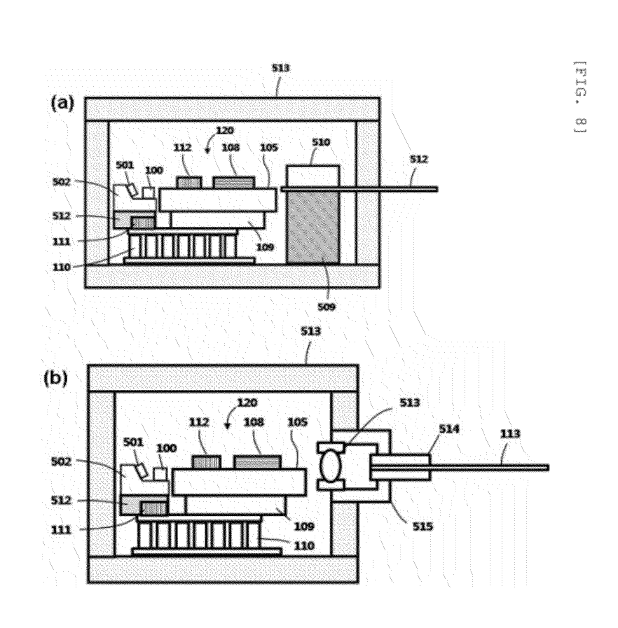

The wavelength tunable external cavity semiconductor laser module according to the present invention may further include a control unit. A temperature control algorithm on the assumption that a channel setting signal is input from the outside when an optical transceiver to which the wavelength tunable external cavity semiconductor laser module according to the present invention is applied is operated in a WDM-PON optical link is shown in FIG. 7. When the channel setting signal is input from the outside, current applied to the thermo-electric cooler 110 of the temperature control apparatus is controlled and stabilized with reference to control values for each channel stored in an erasable programmable read only memory (EPROM) of the optical transceiver, current applied to the heating element 108 is controlled and at the same time, comparison with the resistance reference values of the first temperature sensor 112 for each channel stored in the EPROM is performed through monitoring of a resistance value of the first temperature sensor 112 to control current applied to the thin film heater 108, thereby allowing the resistance value of the temperature sensor to be converged on the reference value. A control through the real time monitoring and feedback of the temperature as described above is performed, thereby making it possible to more rapidly stabilize the temperature and more rapidly stabilize the wavelength accordingly.

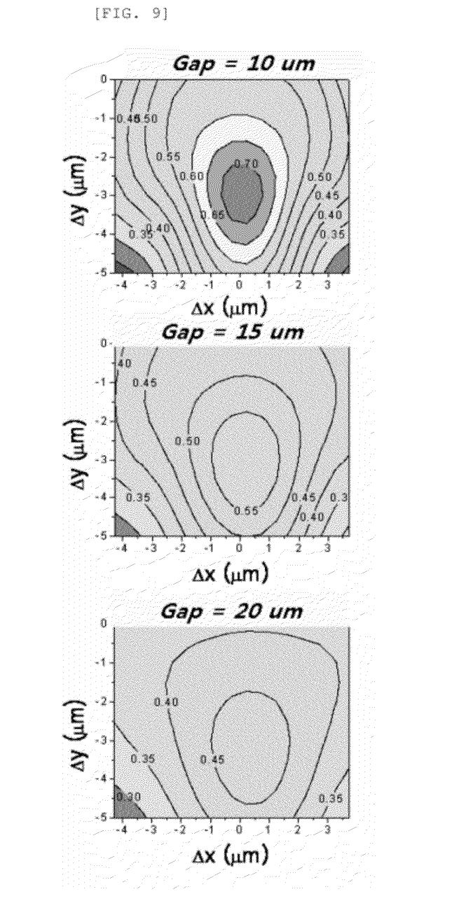

FIGS. 8A and 8B, which show a wavelength tunable external cavity semiconductor laser module according to another exemplary embodiment of the present invention, are views showing a structure in which a light source 100 and a wavelength tunable filter 120 are packaged in the same housing 513, respectively, unlike the exemplary embodiment of FIG. 5. The light source 100 is mounted together with a photodiode 501 for monitoring a change in intensity of oscillating light on an ‘L’ shaped sub-mount 502, a metal layer 512 formed of Cu or Al and having excellent thermal conductivity is positioned on a lower portion of the sub-mount 502, and the sub-mount is mounted on an upper portion of a thermo-electric cooler 110 configuring a temperature control device in a state in which it is fixed to the metal layer 512.

The light source 100 and an optical waveguide of the waveform tunable filter 120 are optically coupled to each other through butt-coupling, thereby forming a resonator. Here, optical coupling efficiency is changed according to an interval between a light emitting surface of the light source 100 and a cross section of the optical waveguide.

Simulation results of optical coupling efficiency according to an interval between a light emitting surface of the light source and a cross section of the optical waveguide on the assumption that divergence angle of beam output from the light source 100 is 22.8 degrees, the optical waveguide has a rib waveguide structure, each of a width and a height of a rib waveguide is 4 μm and 5 μm, and a height of a slap waveguide is 2.5 μm are shown in FIG. 9. In the case in which the interval is 10 μm, the maximum optical coupling efficiency is about 70%, and each of alignment error ranges capable of allowing 1 dB loss in horizontal and vertical directions is 2.5 μm and 3.5 μm. On the other hand, it could be appreciated that in the case in which the interval is 20 μm, the maximum optical coupling efficiency is about 45%, which is reduced by about 40% as compared to the above-mentioned case; however, each of alignment error ranges capable of allowing 1 dB loss in horizontal and vertical directions is 6 μm or more, which is significantly increased as compared to the above-mentioned case. That is, it could be appreciated that as the interval becomes small, the optical coupling efficiency increases; however, the allowable alignment error range decreases; on the other hand, as the interval becomes large, the optical coupling efficiency decreases; however, the allowable alignment error range increases.

Therefore, in the case in which the optical coupling is performed through the butt-coupling without using the optical coupling lens, a spot size converter (SSC) for reducing the divergence angle of the beam emitted from the light source 100 may be integrated in the light source 100 in order to obtain high optical coupling efficiency. In addition, an interval between the light emitting surface of the light source 100 and an incident surface of the optical waveguide is 30 μm or less. As an optical output end, a lens type optical fiber 512 or an optical coupling lens 513 may be used as described in the exemplary embodiment of FIGS. 5A and 5B.

Although the exemplary embodiments of the present invention have been describe in detail with reference to the accompanying drawings, the present invention is not limited to the exemplary embodiments but may be implemented in a modified form without departing from the essential characteristics of the present invention.

1. A wavelength tunable external cavity semiconductor laser module comprising:
a light source generating wideband light;
a semiconductor optical waveguide having one end optically coupled to the light source;
a Bragg grating formed on the optical waveguide;
a thin film heater provided at an upper portion of the Bragg grating and controlling a reflection band of the Bragg grating by a thermo-electric effect;
a first temperature sensor provided at an upper portion of the optical waveguide;
a thermoelectric cooler (TEC) provided at a lower portion of the optical waveguide;
a heat insulating layer provided between the optical waveguide and the TEC; and
an optical fiber optically coupled to the other end of the optical waveguide,
wherein the optical waveguide and the Bragg grating are formed using a silicon on insulator (SOI).

2. The wavelength tunable external cavity semiconductor laser module of claim 1, wherein the light source is a TO-CAN packaged light source including a semiconductor laser diode chip generating the light and a photo diode detecting intensity of the generated light,
the light source and the semiconductor optical waveguide are optically coupled to each other by an optical lens, and
the optical lens is adhered integrally with the TO-CAN packaged light source.

3. The wavelength tunable external cavity semiconductor laser module of claim 2, further comprising a second temperature sensor, wherein the second temperature sensor is provided between the heat insulating layer and the TEC.

4. The wavelength tunable external cavity semiconductor laser module of claim 1, wherein the light source is a light source including a spot size converter integrated therein and a semiconductor laser diode chip and a photo diode mounted on a sub-mount, the semiconductor laser diode chip generating the wideband light and the photo diode detecting intensity of the generated light,
the light source is provided at an upper portion of the TEC and the light source and the optical waveguide are optically coupled to each other by butt coupling, and
the light source and the TEC include a metal layer provided therebetween.

5. The wavelength tunable external cavity semiconductor laser module of claim 4, further comprising a second temperature sensor, wherein the second temperature sensor is provided between the metal layer and the TEC.

6. The wavelength tunable external cavity semiconductor laser module of claim 3, further comprising an optical fiber support supporting the optical fiber, wherein the light source, the optical waveguide having the Bragg grating formed thereon, the thin film heater, the first temperature sensor, the TEC, and the second temperature sensor are provided in a single housing, and the optical fiber is fixed to the housing by the optical fiber support.

7. The wavelength tunable external cavity semiconductor laser module of claim 6, wherein the optical waveguide and the optical fiber are optically coupled to each other by optical lens coupling or butting coupling.

8. The wavelength tunable external cavity semiconductor laser module of claim 1, wherein the optical waveguide is a silicon optical waveguide formed in a silicon on insulator (SOI) substrate including a lower silicon layer, a buried silicon oxide layer, and an upper silicon layer and including a silicon core, a lower clad, which is the buried silicon oxide layer, and an upper clad formed of air or silicon oxide.

9. The wavelength tunable external cavity semiconductor laser module of claim 8, wherein the Bragg grating is formed by selectively etching the silicon core and is formed of the air or the silicon oxide.

10. The wavelength tunable external cavity semiconductor laser module of claim 9, wherein the optical waveguide is a silicon optical waveguide having a channel shape, a rib shape, or a ridge shape.

11. The wavelength tunable external cavity semiconductor laser module of claim 9, wherein the Bragg grating has a structure in which at least one Bragg grating is connected in series with each other, and the at least one Bragg grating is a first order Bragg grating, a third order Bragg grating, a fifth order Bragg grating, or an nth order Bragg grating (n is an odd number larger than 5) independent of each other.

12. The wavelength tunable external cavity semiconductor laser module of claim 1, wherein the heat insulating layer is formed of glass.

13. The wavelength tunable external cavity semiconductor laser module of claim 6, wherein the optical waveguide is tilted so as to satisfy the Snell's law at the time of optical coupling between the light source and the optical waveguide.

14. The wavelength tunable external cavity semiconductor laser module of claim 5, further comprising an optical fiber support supporting the optical fiber, wherein the light source, the optical waveguide having the Bragg grating formed thereon, the thin film heater, the first temperature sensor, the TEC, and the second temperature sensor are provided in a single housing, and the optical fiber is fixed to the housing by the optical fiber support.
